(19) United States
(12) Patent Application Publication
(10) Pub. No.: US 2011/0206835 A1
(43) Pub. Date: Aug. 25, 2011

(54) Borate and polymer compositions for the repair and maintenance of railroad ties

(76) Inventors: Doug Delmonico, Broomfield, CO (US); Fabian Weber, Boulder, CO (US)

(21) Appl. No.: 12/931,595

(22) Filed: Feb. 3, 2011

Related U.S. Application Data
(60) Provisional application No. 61/301,091, filed on Feb. 3, 2010.

(51) Int. Cl. C09D 175/04; B05D 3/12; C08J 9/35

(52) U.S. Cl. 427/140; 521/103

(57) ABSTRACT

A remedial railroad tie repair treatment capable of extending the useful life of a railroad tie. The remedial repair treatment comprises a mixture of a borate solution and a chemical tie plugging compound combined that, when applied to a wooden area of interest, will delay the decay thereof and facilitate penetration of the borate through the wood fibers. The remedial repair treatment may alternatively comprise sequential application of the borate solution and the plugging compound to the wooden area of interest.

This application claims the benefit of U.S. Provisional Application No. 61/301,091, filed Feb. 3, 2010, which is hereby incorporated by reference in its entirety.

### BACKGROUND OF THE INVENTION

Wood is the predominate material used for railroad ties, due in large part to its widespread availability, low cost, industry familiarity, and the conventional mastery of its physical and engineering characteristics. Railroad ties conventionally comprise a decay-susceptible heartwood core surrounded by a band or shell of sapwood that has been pressure treated with preservative compositions. The preservative compositions used to treat the railroad ties generally comprise creosote, either alone or in combination with other preservatives including borates (i.e. boric acid and its salts) and copper naphthenate. These compounds are typically used to treat the sapwood layer of the wooden railroad ties in addition to creosote in order to prevent attack by fungi and insects, as there is limited penetration of creosote into ties. However, certain preservative treatments—boric acid and its water-soluble salts, in particular—are extremely mobile in wood in the presence of water. Continued exposure to weather can leach the preservative treatments from the tie very rapidly, thereby making the tie more susceptible to attacks from insects or fungi. While subsequent treatment of the tie with creosote or another sealer may prevent such leaching, such treatments can be compromised through normal wear and tear.

Provided the treated shell of a railroad tic remains intact and a sufficient amount of preservatives remain within the wood, the useful life of railroad ties can be over 30 years. However, the leaching of preservative treatments is not the only manner through which treated ties may be weakened. The development of checking or cracking in the tie may permit penetration of the creosote layer and allow entry of either fungi or insects into the untreated heartwood, which could lead to early failure. Similarly, processes such as driving spikes or drilling holes for spikes or other hardware that occur after the preservative treatment is applied may also promote early failure as such processes provide an entry point for moisture and fungi into the wood. While it is conventionally known to repair spike holes by filling the void with a plugging compound, such chemical compounds do little to repair and/or kill any existing fungi within the tie or prevent the spread of the same.

Similarly, part of the general maintenance of a railroad system involves adzing the top of each wood tie at or near the location of the plate, the rail seat area, to ensure the surface of the tie is even and the tie plates lie flat thereon. When this adzing process is performed, about an 18 inch surfacing cut across the tie exposes the fibers of the untreated wood of the tie. This area of the tie, the rail seat, is the most probable area of the tie to be damaged by tie plates cutting into the tie and therefore a likely entry point for fungi. Any adzing and/or cutting that occurs during the periodic maintenance of a tie necessarily removes the preservative treatment that was originally applied and thus leaves untreated wood exposed and vulnerable to fungi and insect damage.

### SUMMARY OF THE INVENTION

Compositions are provided for the remedial treatment of a railroad tie and, specifically, to prevent the decay thereof. In at least one embodiment, the composition comprises a plugging compound and a borate. The plugging compound may be adapted to undergo a reaction that produces heat, such as a quick-curing compound that undergoes an exothermic reaction. The borate may comprise any borates known in the art and, in at least one embodiment, the borate may comprise a borate solution.

Methods for using the above-described composition to remedially treat a decaying railroad tie are also disclosed herein. In at least one embodiment, a method for remedially treating decay of a railroad tie comprises the steps of applying a borate solution to a railroad tie, the borate solution adapted to diffuse through at least a portion of the railroad tie; applying a plugging compound to the railroad tie, the plugging compound adapted to undergo a reaction that produces heat; facilitating the reaction of the plugging compound; and employing the heat of the reaction to facilitate penetration of the borate solution into at least a portion of the railroad tie.

Additionally, at least one embodiment is described of a method for remedially treating decay of a railroad tie comprising the steps of applying a composition to a railroad tie, the composition comprising a borate solution and a plugging compound, the borate solution adapted to facilitate penetration of the borate through at least a portion of the railroad tie and the plugging compound adapted to undergo a reaction that produces heat; facilitating the reaction of the plugging compound; and employing the heat of the reaction to facilitate penetration of the borate solution into at least a portion of the railroad tie. Alternatively, in at least one embodiment a composition comprising a borate solution and a sealing compound may be employed in connection with the steps of the method, where the sealing compound is adapted to form a barrier at or near an exterior surface of the railroad tie.

### BRIEF DESCRIPTION OF THE DRAWINGS

FIG. 1 shows a line drawing representation of a photograph of a cross-section of a simulated spike hole that has been treated with a spray composition as set forth in Example 1;

FIG. 2 shows a line drawing representation of a photograph of a cross-section of a simulated spike hole that has been treated with a foam composition as set forth in Example 2;

FIG. 3 shows a line drawing representation of a photograph of a cross-section of a simulated spike hole that has been treated with both spray and foam compositions as set forth in Example 3;

FIG. 4a shows a line drawing representation of a photograph of cross-sections of spike holes in oak ties that have been treated with a liquid composition and thereafter a foam composition (as set forth in Example 4), prior to the application of a borate indicator; and

FIG. 4b shows a line drawing representation of a photograph of cross-sections of the spike holes of FIG. 4a after the application of a borate indicator and the borate penetration therein.

### DETAILED DESCRIPTION OF THE INVENTION

Reference will now be made to various embodiments and specific language will be used to describe the same. It will nevertheless be understood that no limitation of scope is intended by the description of these embodiments.

Supplementary or remedial treatments can be used to materially increase the useful life of ties. Specifically, the in situ application of a repair composition described herein to a railroad tie has shown to significantly extend the useful life of a railroad tie. Unlike the preservative treatments applied to railroad ties during the manufacturing process, remedial application of the repair composition to a railroad tie is a second line of defense that may be employed in the field on an as-needed basis. Specifically, the repair composition described herein is capable of delaying the overall decay of the wood, killing any existing fungi that may be present within the wood ties, and penetrating the wood fibers to prevent the spread of such fungi and the associated decay in the event external factors have reduced or obviated the effects of any preservative treatments that were initially applied during the tie manufacturing process.

The repair composition comprises a plugging compound for repairing the physical damage to the tie and a borate. The plugging compound and borate are each present in the repair composition in sufficient amounts such that when the repair composition is applied to a void left in a wood railroad tie from a spike or otherwise, the repair composition is capable of delaying the decay of the wood railroad tie, killing any existing fungi present therein, and preventing the spread of decay caused by said fungi throughout the wood.

The repair composition may be a curable polymer system or composition, as are known in the art. In at least one embodiment, the polymer system is cured by an exothermic reaction. In addition to the preservative properties of the individual components of the repair composition, application of the repair composition to a tie exploits the exothermic curing reaction of the plugging compound to not only kill any fungi surrounding the void, but also facilitate the penetration of the borate through the wood. Accordingly, remedial application of the repair composition to a compromised railroad tie repairs decay by filling the cavities and other damaged areas of the tie with a plugging compound that simulates the material of the tie, and by applying borate, a known biocide, directly to the contaminated areas of the tie, and prevents any future development of the same, assuming the compromised area of the tie was in the vicinity of the hole being repaired. In this manner, the useful life of the laid tie is extended, which ultimately reduces the overall costs associated with replacing failed railroad ties.

The plugging compound of the repair composition comprises any chemical tie plugging repair material known in the art, including polymer compositions such as a chemical polyurethane compound, a polyurea compound, a chemical urethane compound, an epoxy compound, a polyol compound, a quick-curing polymer, or a combination of any of the aforementioned. In at least one embodiment, the plugging compound comprises a high-density polyurethane. In an alternative embodiment, the repair composition comprises a 2-component plugging compound having about a 1:1 or 1:2 ratio by volume of isocyanate and polyol, where borate is incorporated into at least one of the components. The plugging compound is preferably formulated to develop a density similar to that of the wood or other material to which it is to be applied. For example, and without any intended limitation, the plugging compound may form about a 38 to 45 pound per cubic foot density. In this manner, when the plugging compound is used to fill a spike hole or a portion thereof, the plugging compound can retain a spike as efficiently as did the original wood.

The borate of the repair composition may comprise any borate that is suitable for the chemical preservation of wood, including, without limitation, the commercially available borate products Am Bor S, Am Bor P, KM-Bor, Tim-Bor®(U.S. Borax Inc.), Borogard ZB® (U.S. Borax Inc.) or any Busan® (Buckman Labs. Int'l, Inc.) or similar product currently used at tie treatment plants in the manufacture of railroad ties. Further, a borate mixture can be employed such that the borate is mixed or dissolved into a liquid medium (aqueous, polymer-based or otherwise) capable of dissolving or suspending the borate for a period of time.

Dissolution or suspension of the borate in a liquid medium provides many advantages with respect to ease of application in the field. For example, and without limitation, a dissolved form of borate may be easily applied to a laid railroad tie by pouring or spraying. In at least one embodiment, the medium for applying the borate is especially formulated to facilitate the migration of the borate into the untreated wood fibers, yet dries quickly to ensure that the borate cannot inadvertently leach from the tie, as in the case of subsequent precipitation. The borate mixture can also be formulated to retain the borate within the tie until the conditions are optimal to promote maximum diffusion of the borate throughout the fibers of the wood, such as when the moisture absorption of the tie increases due to local seasonal moisture variations.

The repair composition can be applied directly to a vacated spike hole in a tie. In at least one embodiment, once in the vacated spike hole, the plugging compound undergoes an exothermic reaction as it cures, which functions to kill any existing fungi in or adjacent to the spike hole. Surprisingly, the heat produced from the exothermic reaction is also found to dramatically promote the dispersion or diffusion of the borate beyond the immediate area of the spike hole or other damaged area and into the wood fibers of the body of the tie. In this manner, the borate not only prevents future fungi from entering the wood in the vicinity of the spike hole, but also kills any fungi that has moved into the wood fibers beyond the limited reach of the heat of the exothermic reaction. The chemical plugging compound acts to fill and seal the hole and rot cavity, should a cavity exist, to prevent any future ingress of water and/or microbes into the untreated wood.

Additionally, the repair composition may also be employed to treat damage to the tie such as an adzed, cut, or otherwise stripped portion of the surface of a railroad tie. Treatment of the exposed, untreated wood with the repair composition can thus prevent the invasion of fungi, moisture and/or insects into the untreated portion of the tie. It will be appreciated that the specific formulation of the repair composition may be selected depending on the desired application. For example, in treating an adzed surface of a railroad tie, a repair composition comprising a rapid-curing polymer material (to function as a sealer) and a borate, may be selected, whereas a repair composition comprising a polyurethane or polyurea, epoxy or similar plugging compound and a polymer-based borate mixture may be selected for treatment of a spike hole.

In application, the repair composition may be applied to the compromised railroad tie either as a mixture or through the sequential application of its individual components. For application of the repair composition as a mixture, the borate (either alone or in combination with a specifically formulated medium) is first combined with the plugging compound in the desired component ratios. Thereafter, the repair composition is added directly to the compromised portion of the railroad tie. Alternatively, the components of the repair composition may be applied sequentially. In at least one embodiment, the borate of the repair composition is added directly to the compromised portion of the tie, either by a spray or otherwise, prior to the application of the plugging compound. The plugging compound is subsequently applied to repair the physical damage to the tie.

As previously described, once the repair composition is applied to the tie, the exothermic reaction of the plugging compound facilitates the penetration of the borate or borate mixture into the surrounding wood fibers and kills any fungi immediately adjacent thereto. In this manner, after the plugging compound has set, the borate remains locked within the interior of the tie, thus preventing any future insect or fungi attack and the associated decay of the wood. The end result is a restored railroad tie that need not be replaced.

The following examples illustrate the compositions of repair compositions, their preparation, and application as remedial preservatives and the swift and extensive movement of the borate into the wood. The Figures described below serve to demonstrate the improved results described herein. The examples provided are not meant to limit the scope hereof, as is solely defined by the claims.

### EXAMPLE 1

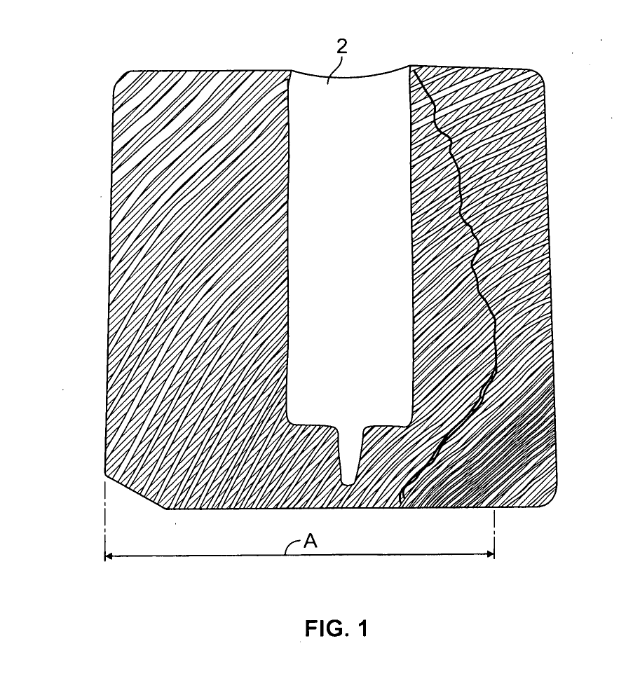

A sprayable borate composition was prepared by blending together: 20% borate (Tim-Bor® from U.S. Borax, Inc.) and 80% water, by weight. This composition was sprayed into a simulated spike hole 2 in a Douglas Fir test specimen and allowed to diffuse. After 24 hours, the test specimen was saw cut through the treated spike hole and analyzed. The extent of diffusion of borate was determined by spray application of a boron indicator using the test procedure described in the American Wood Protection Association book of standards (standard A3-08 section 17). Boron present in an amount of 0.8 kg/m³ or greater will turn the indicator reagent red. As shown in FIG. 1, the borate penetrated a distance A into the wood.

### EXAMPLE 2

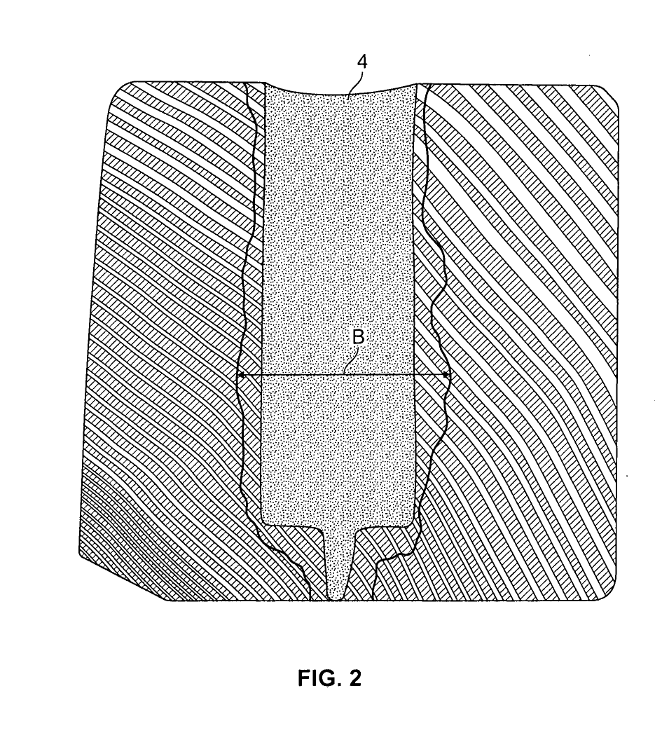

A foam repair composition was prepared by blending together: about 2.5% borate (Tim-Bor® from U.S. Borax, Inc.) and about 2.5% fumed silica (Cab-o-sil® TS-720 from Cabot Corporation) by weight into the polyol component, part “B”, of a standard 2-part foaming polyurethane. The fumed silica was used as a thickening agent to reduce the amount of settling out and keep the borate in suspension in the polyol. The polyurethane compound was then prepared as a 1:1 ratio by volume of isocyanate to polyol. This composition was applied into a simulated spike hole in a Douglas Fir test specimen and allowed to rest and form a plug 4. After 24 hours, the specimen was saw cut through the treated hole and analyzed as described in Example 1. As shown in FIG. 2, the borate penetrated a distance B into the wood.

### EXAMPLE 3

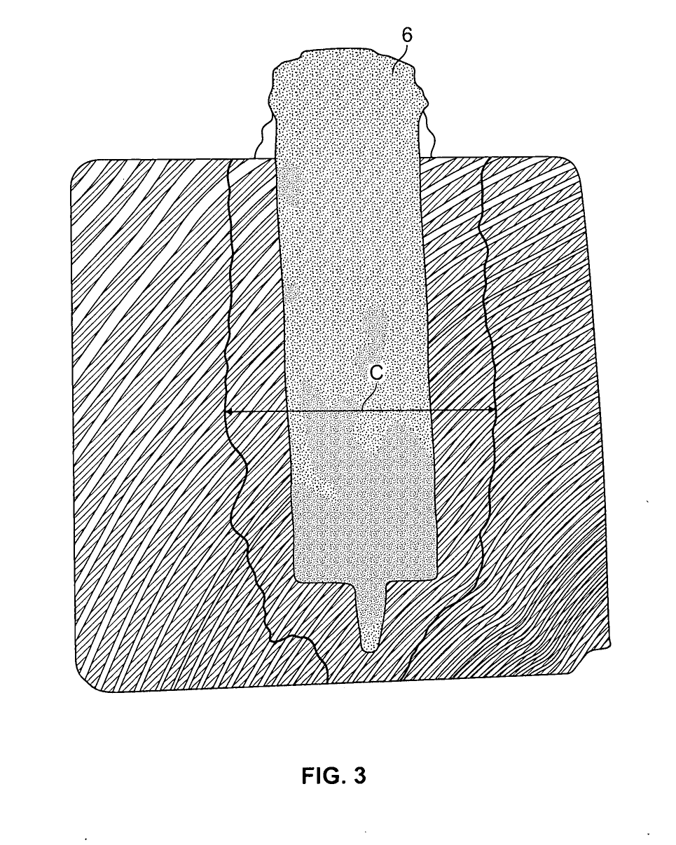

A simulated spike hole in a Douglas Fir test specimen was spray treated with the 20% borate (Tim-Bor® from U.S. Borax, Inc.) solution of Example 1 and allowed to rest for 24 hours. Thereafter, a plugging compound consisting of a Two-Component Spike Hole Filler polyurethane foam (from Encore Rail Systems, Inc.) was applied into the borate treated hole and allowed to cure and form a plug 6. After 24 hours, the specimen was saw cut through the treated hole and analyzed as described in Example 1. As shown in FIG. 3, the borate penetrated a distance C into the wood.

### EXAMPLE 4

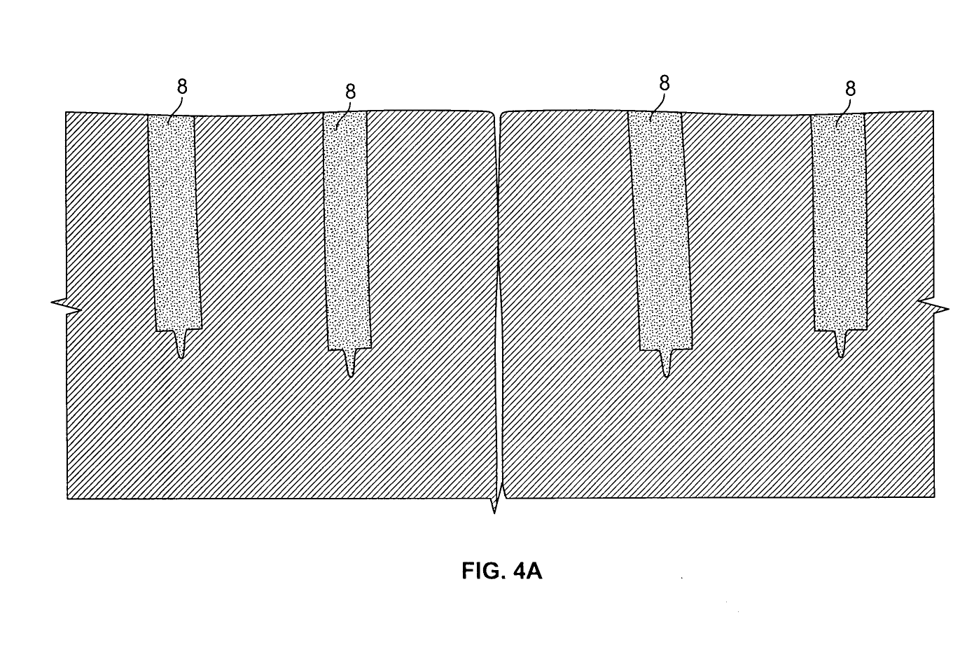

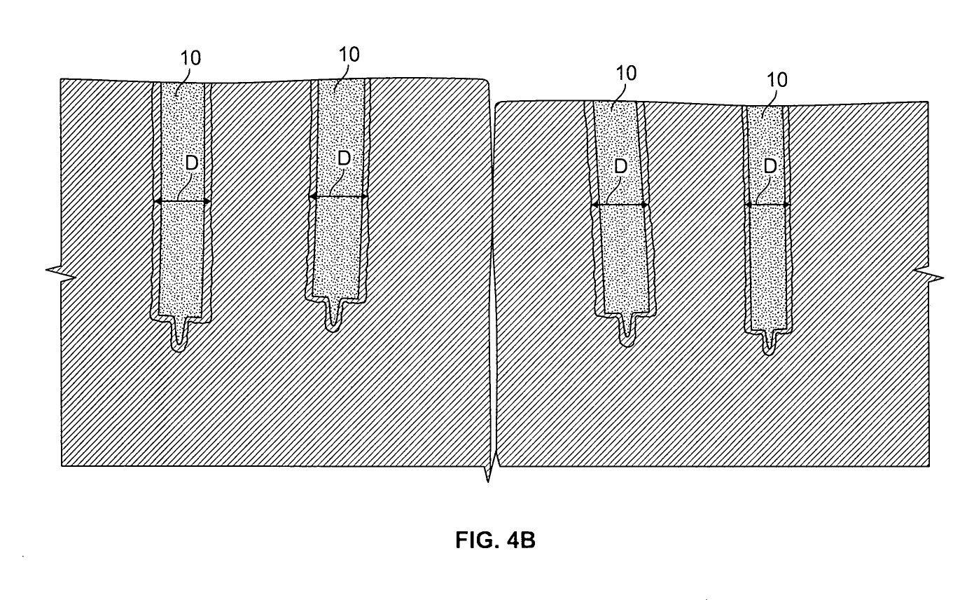

A liquid composition was prepared by blending together: 30% borate (Tim-Bor® from U.S. Borax, Inc.) by weight and an MPX wood coating material containing a black stain obtained from Advantage Coatings (Louisville, Colo.) as a liquid medium. This composition was poured into a spike hole in an otherwise untreated oak tie and allowed to rest. After 24 hours, the 1:1 ratio by volume polyurethane foam composition of Example 2 containing borate was applied to the spike hole and allowed to rest for about 24 hours and form a plug 8, 10. Thereafter, the spike hole was saw cut through the treated hole and analyzed as described in Example 1. FIG. 4a shows the cross section prior to application of the borate indicator but after the applied polyurethane foam composition was allowed to rest, and FIG. 4b illustrates that the borate penetrated a distance D into the wood after the borate indicator was applied per the AWPA test described in example 1.

Those of skill in the art will appreciate that the degree of penetration or diffusion of the borate into the wood may vary according to the species of wood, and the conditions of application. Wood specimens that have larger vessels with fewer obstructions are likely to exhibit greater diffusion of borate. For example, it has been observed that the degree of penetration of borate is greater in sample ties made of red oak in comparison to white oak. It has also been observed that wood specimens that have been pre-soaked with water also exhibit somewhat greater diffusion of borate into the wood.

While various embodiments of a repair composition, and methods for producing and using the same have been described in considerable detail herein, the embodiments are merely offered by way of non-limiting examples of the disclosure described herein. Many variations and modifications of the embodiments described herein will be apparent to one of ordinary skill in the art in light of this disclosure. It will therefore be understood by those skilled in the art that various changes and modifications may be made, and equivalents may be substituted for elements thereof, without departing from the scope of the disclosure. For example, it will be understood that any type of plugging compound or plugging media, such as wood dowels, may be employed in the repair composition disclosed herein. Indeed, this disclosure is not intended to be exhaustive or to limit the scope of the disclosure. The scope of the disclosure is to be defined by the appended claims, and by their equivalents.

It is therefore intended that the disclosure will include, and this description and the appended claims will encompass, all modifications and changes apparent to those of ordinary skill in the art based on this disclosure.

What is claimed is:

1. A composition for the treatment of railroad ties, comprising: a curable polymer composition; and a borate compound.

2. The composition of claim 1, wherein the polymer composition is cured by an exothermic reaction.

3. The composition of claim 1, wherein the polymer composition is selected from the group consisting of: a polyurethane compound, a polyurea compound, an epoxy compound, and combinations thereof.

4. The composition of claim 1, wherein the polymer composition is a 2-component polyurethane compound comprising an isocyanate and a polyol.

5. The composition of claim 4, wherein the polyurethane compound comprises a ratio of isocyanate to polyol of about 1:1.

6. The composition of claim 4, wherein the polyurethane compound comprises a ratio of isocyanate to polyol of about 1:2.

7. The. composition of claim 4, wherein the borate compound is incorporated into the polyol in an amount of about 2.5% borate by weight.

8. The composition of claim 1, wherein the polymer composition has a density in a range of about 38 to 45 pounds per cubic foot after curing.

9. The composition of claim 1, wherein the borate compound comprises a solution or suspension in a liquid medium of about 20% borate by weight.

10. A method for the repair of damaged railroad ties, comprising:
applying a borate compound to the damaged surface of the railroad tie;
applying a curable polymer composition to the damaged surface of the railroad tie; and
curing the polymer composition to repair the damaged surface of the railroad tie.

11. The method of claim 10, wherein the polymer composition is cured by an exothermic reaction.

12. The method of claim 10, wherein the borate compound comprises a solution or suspension in a liquid medium of about 20% borate by weight.

13. The method of claim 10, further comprising the steps of:
mixing the borate compound and polymer composition; and
applying the mixture to the damaged surface of the railroad tie.

14. The method of claim 13, wherein the polymer composition is a 2-component polyurethane compound comprising an isocyanate and a polyol.

15. The method of claim 14, further comprising the steps of:
incorporating the borate compound into the isocyanate and/or polyol; and
applying the mixture of the borate compound and polymer composition to the damaged surface of the railroad tie.

16. The method of claim 15, wherein the borate compound is blended into the polyol in an amount of about 2.5% borate by weight.

17. The method of claim 10, wherein the borate compound comprises a solution or suspension in a liquid medium, and further comprising the step of applying the borate compound to the damaged surface of the railroad tie by spraying.

18. The method of claim 10, wherein the borate compound comprises a solution or suspension in a liquid medium of about 20% borate by weight.

19. The method of claim 10, wherein the damaged surface of the railroad tie is a vacated spike hole.

20. The method of claim 10, further comprising the steps of:
adzing the surface of the railroad tie; and
applying the borate compound and the curable polymer composition to the adzed surface.

21. A method for treating railroad ties, comprising:
providing a first borate compound, and a 2-component polyurethane compound comprising an isocyanate and a polyol;
mixing the first borate compound and the polyol;
preparing the polyurethane compound from the mixture of the first borate compound and the polyol and the isocyanate;
applying a second borate compound to the railroad tie;
applying the polyurethane compound to the railroad tie;
curing the polyurethane compound.

22. The method of claim 21, wherein the borate compound is mixed into the polyol in an amount of about 2.5% borate by weight

23. The method of claim 21, wherein the polyurethane compound is prepared as a 1:1 ratio by volume of isocyanate and polyol.

24. The method of claim 21, wherein the second borate compound comprises about 30% borate by weight in a liquid medium.
